(19) United States
(12) Patent Application Publication
(10) Pub. No.: US 2007/0293236 A1
(43) Pub. Date: Dec. 20, 2007

(54) SYSTEM AND METHOD FOR CABLING

(75) Inventors: Aaron R. Cox, Tucson, AZ (US); Daniel Loewus-Deitch, Tucson, AZ (US); Mark E. Molander, Cary, NC (US); Teresa S. Swingler, Tucson, AZ (US); Ronald E. Van Buskirk, Tucson, AZ (US)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/420,315

(22) Filed: May 25, 2006

(51) Int. Cl. H04Q 7/20

(52) U.S. Cl. 455/456.1

(57) ABSTRACT

Disclosed is a system for cabling including a component network comprising a server that includes a server wireless detector and at least one server LED associated with at least one server port, and at least one satellite device, each of the at least one satellite devices including a satellite wireless detector that is detectable by the server wireless detector and at least one device LED associated with at least one device port, a relative position coordinator associated with the server and each of the at least one satellite devices, and an interactive map generation tool associated with the server, the map directing a user through a cabling path process via an information link between the server and at least one satellite device and a physical location map.

### FIELD OF THE INVENTION

The disclosure relates generally to a system and method for cabling a component network, and more particularly to a system and method for cabling a component network including interactive guidance.

### BACKGROUND OF THE INVENTION

Physically cabling hardware in a large, complex server or storage environment is often a challenging and time-consuming task. Determining where to route each cable in such an environment is a particular point of difficulty for customers. Currently there are four common solutions to make storage area network cabling easier. One solution involves color or pattern-coding wires, connector ends, and ports. However, if any more than about 5 different colors/patterns are necessary, the color/pattern-coding can be more confusing than helpful. Also, color/pattern-coding alone will not meet accessibility requirements for color-blind users. Another solution involves physically designing connectors and ports so they must be connected in the right orientation (i.e. certain cables will only fit and associate with certain ports). While this solution is helpful if there are a few connections to be made that are all of different types, physical design is not helpful for systems that involve multiple connections of the same type (and thus use the same cables). All of these issues also extend to complicated home entertainment systems and concert sound systems.

The other two solutions involve cabling diagrams and setup wizards. Cabling diagrams offer a user a step-by-step process for cabling, but do not offer any information regarding physical location of network devices, or feedback regarding completed connection or error. Similarly, while setup wizards can offer some feedback, they also fail to offer any information regarding physical location of network devices.

For at least the foregoing reasons, a more user friendly and efficient method for SAN and other complex cabling environments is desirable.

### SUMMARY

Disclosed is a system for cabling including a component network comprising a server that includes a server wireless detector and at least one server LED associated with at least one server port, and at least one satellite device, each of the at least one satellite devices including a satellite wireless detector that is detectable by the server wireless detector and at least one device LED associated with at least one device port, a relative position coordinator associated with the server and each of the at least one satellite devices, an interactive map generation tool associated with the server that is capable of acquiring information about each of the at least one satellite devices via an information link between the server wireless detector and the satellite wireless detectors, generating an interactive physical location map of the at least one satellite device and the server via the relative position coordinators, and directing a user along a cabling path process by systematically flashing icons associated with each of the at least one server ports and each of the at least one device ports on the physical location map, while flashing the device LEDs and server LEDs that are associated with each of the at least one server ports and each of the at least one device ports that correspond with the flashing icons.

Also disclosed is a method for cabling including powering a server wireless detector disposed in a server a component network, the server including at least one server port, powering a satellite wireless detector disposed in at least one satellite device of the component network, each of the satellite devices including at least one device port, detecting the at least one satellite device via an information link between the server wireless detector and the satellite wireless detectors, acquiring information about the at least one satellite device via the information link between the server wireless detector and the satellite wireless detectors, generating an interactive physical location map of the at least one satellite device and the server via the information link, an interactive map generating tool, and a relative position coordinator disposed in the server and each of the at least one satellite devices, generating a cabling path process via the map generating tool, indicating cable-ability along the cabling path process and within the component network by systematically flashing icons associated with each of the at least one server ports and each of the at least one device ports on the physical location map, systematically flashing a device LED associated with each of the at least one device ports corresponding with the flashing icons and a server LED associated with each of the at least one server ports corresponding with the flashing icons, and directing a user along the cabling path process via the indicating.

### BRIEF DESCRIPTION OF THE DRAWINGS

The foregoing and other features and advantages of the present invention should be more fully understood from the following detailed description of illustrative embodiments taken in conjunction with the accompanying Figures in which like elements are numbered alike in the several Figures:

FIG. 1 is a schematic of an un-cabled component network;

FIG. 2 is a schematic of a portion of the un-cabled component network, indicating a device to be cabled;

FIG. 3 is a schematic of a portion of the component network, illustrating a device that is cabled;

FIG. 4 is a schematic of a portion of the component network, indicating a device that has been cabled in error;

FIG. 5 is a flow chart illustrating a cabling path process; and

FIG. 6 is a block diagram illustrating a method for cabling a component network.

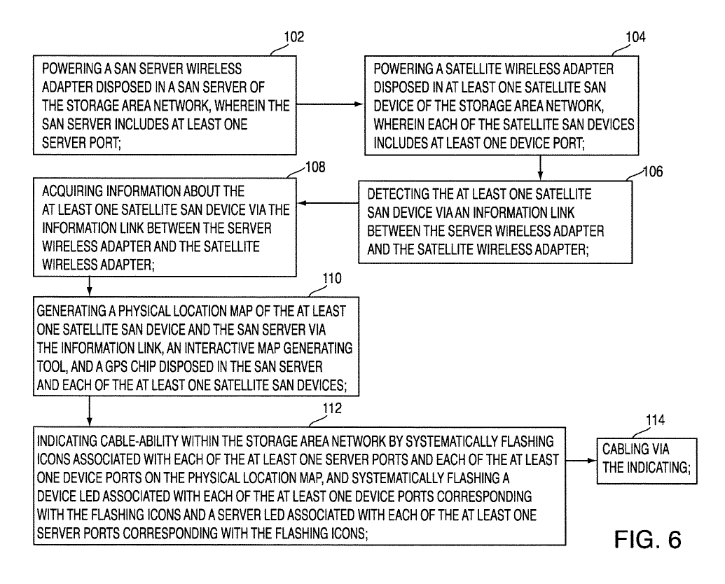

### DETAILED DESCRIPTION

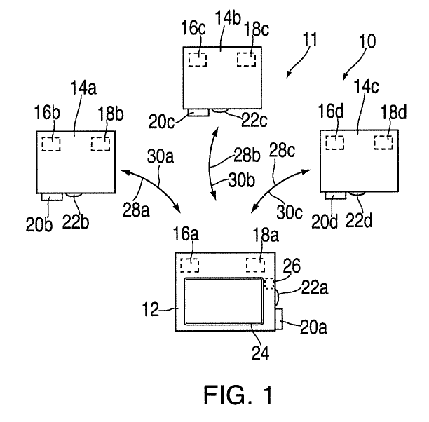

Referring to FIGS. 1-5, a system 10 for cabling is illustrated and includes a component network 11 comprising a server 12 and at least one satellite device 14a-c. The server 12 includes a server wireless detector 16a, a relative position coordinator 18a, at least one server port 20a, at least one server LED 22a associated with the at least one port 20a, an interactive map generating tool 26, and (possibly) a view screen 24 (all of the features included with the server 12 will be discussed in greater detail below). Each of the at least one satellite devices 14a-c includes satellite wireless detectors 16b-d, relative position coordinators, at least one device port 20b-d, and at least one device LED 22b-d associated with the device ports 20b-d (all of the features included with the satellite devices 14a-c will be discussed in greater detail below). The component network 11 described herein and above could be any cabling environment (particularly a relatively complex cabling environment), such as a storage area network (SAN), a complex home entertainment network, or a concert sound system.

With the elements of the system 10 introduced, the manner in which these elements associate will now be discussed, beginning with the wireless detectors 16a-d. The server wireless detector 16a is associated with the server 12. This association may occur via internal or external linkage, wherein the server wireless detector 16a may be disposed within, upon, or separately from the server 12. When powered up, the server wireless detector 16a can locate other, powered up wireless detectors in the component network 11, such as the satellite wireless detectors 16b-d. The server wireless detector 16a detects the satellite wireless detectors 16b-d that are internally or externally associated with the satellite devices 14a-c using technology such as universal plug and play (UPnP™). This detection is represented in the Figures as information link 28a-c. Information 30a-c, to be discussed in greater detail hereinbelow, travels from the satellite devices 14a-c to the server 12 via the wireless detectors 16a-d that create the information links 28a-c.

Upon wireless arrival of the information 30a-c at the server 12 via the information links 28a-c, the interactive map generating tool 26 (introduced briefly above) acquires basic data pertaining to the satellite devices 14a-c from the information 30a-c. The interactive map generating tool 26 may be added as a feature to any type of centralized management software, such as IBM TotalStorage software and IBM Director software. The basic data acquired may include satellite device 14a-c features such as, device type and device port number and type. The map generating tool 26 is also associated/linked with the server 12 in a manner that allows the tool 26 to acquire basic data, such as server type and server port number and type, from the server 12.

The interactive map generating tool 26 also acquires physical location coordinates pertaining to each of the satellite devices 14a-c from the information 30a-c. These coordinates can be acquired via the relative position coordinators 18b-d (introduced briefly above) associated internally or externally with the satellite devices 14a-c and linked/associated with the device wireless detectors 16b-d. Also, the relative position coordinator 18a included in the server 12, which may also be internally or externally associated, is associated/linked with the map generating tool 26, allowing the interactive map generating tool 26 to acquire physical location coordinates of the server 12. If the server 12 is a laptop or other mobile device, this will allow tracking of the server 12 as it moves with a system administrator. It should be appreciated that the relative position coordinators 18a-d of both the server 12 and satellite devices 14a-c may be any position locating device, such as a GPS chip or a wireless triangulation device.

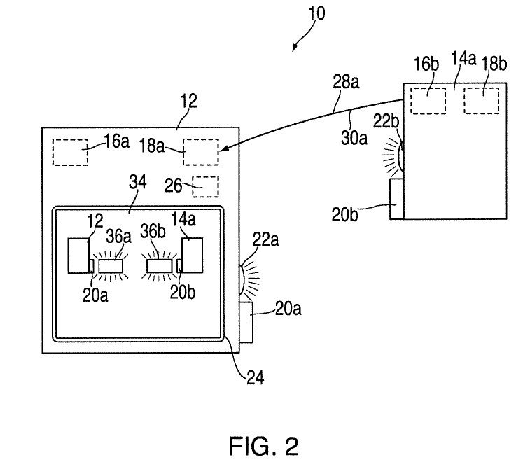

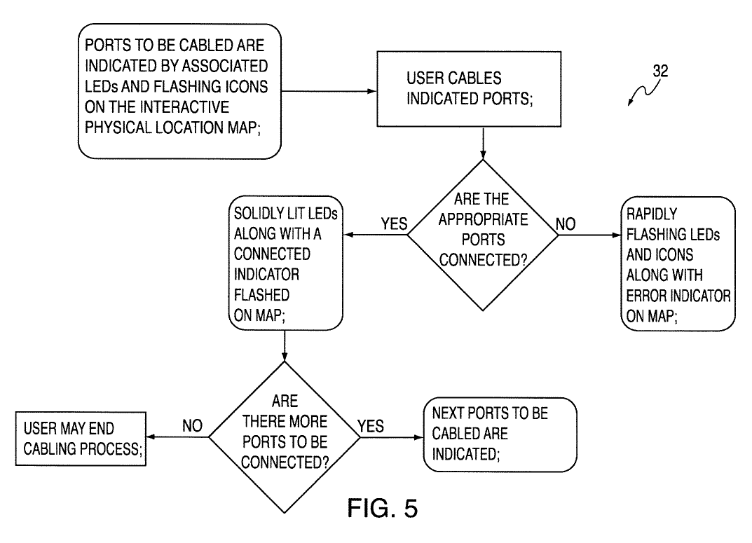

Once the interactive map generating tool 26 has acquired the data pertaining to satellite device 14a-c and server 12, including physical location of each, the interactive map generating tool 26 can direct (when enabled by a user) the user through a cabling path process 32 as is illustrated the flow chart (FIG. 5). Direction through the cabling path process 32 will include generation of an interactive physical location map 34 located on the view screen 24 (or some other viewing device) as well as LED 22a-d activation (to be discussed below). Referring to the physical location map 34, direction through the cabling path process 32 includes systematically flashing icons 36a and 36b corresponding to the ports 20a-d to be cabled. As shown in FIG. 2 for example, the physical location map 34 is indicating that the server port 20a should be cabled with the device port 20b by flashing the icons 36a and 36b. During this process, the map 34 is also demonstrating the physical location (via the relative position coordinators 18a-b) of the server 12 in relation to the satellite device 14a that includes the device port 20b. In addition, the map 34 is also demonstrating location of the device port 20b and server port 20 a on the satellite device 14a and server 12 respectively.

Referring to activation of the LEDs 22a-d, direction through the cabling path process 32 also includes systematically flashing the LEDs 22a-d corresponding to the server and device ports 20a-d to be cabled. As shown in FIG. 2 for example, the LED 22a associated with the server port 20a and the LED 22b associated with the device port 20b are simultaneously flashing to indicate to the user that these ports are to be cabled. Flashing of the LEDs 22a-b is achieved via command of the interactive map generating tool 26, which sends flashing information to the satellite device 14a and LED 22b via the information link 28a. By flashing respective LEDs 22a-d associated with ports 20a-d to be cabled, the user has a physical, real world indication of ports to be cabled in the component network 11.

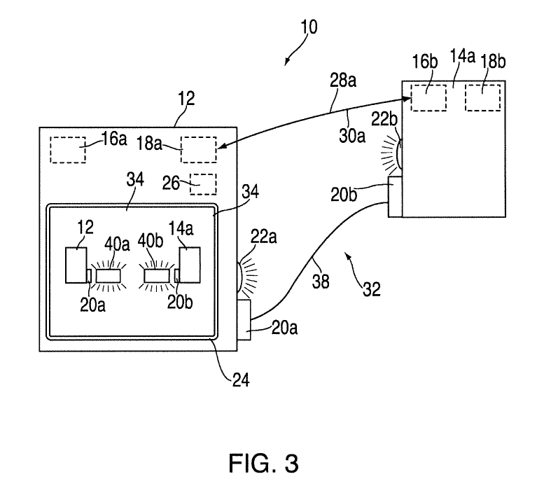

When the user actually connects indicated ports 20a-d with appropriate cable 38, the interactive map generating tool 26 will further indicate to the user that the right ports have been cabled. Referring to FIG. 3, server port 20a and device port 20b were indicated for cabling, and the user has properly cabled server port 20a with device port 20b. Because the proper ports have been cabled, the map 34 flashes an icon (or icons) 40 indicating connection, and the LEDs 22a and 22b associated with the properly connected ports 20a and 20b become solidly lit. At this point, the user knows he has properly cabled the ports 20a and 20b, and the interactive map generating tool 26 will indicate the next ports to be connected with flashing icons on the map 34 and flashing LEDs associated the appropriate ports.

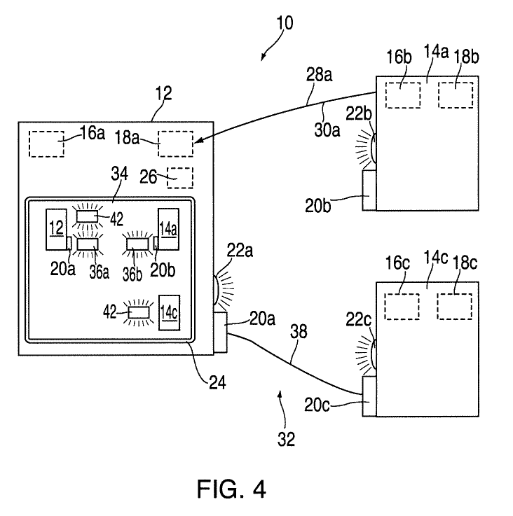

If however, the wrong ports have been cabled, the interactive map generating tool 26 will stop the cabling path process 32 and indicate to the user that the wrong ports have been cabled. Referring to FIG. 4, server port 20a and device port 20b were indicated for cabling, but the user mistakenly cabled server port 20a with device port 20c. Because the wrong ports have been cabled, the map 34 flashes an icon (or icons) 42 indicating error, and the LEDs 22a and 22c associated with the improperly connected ports 20a and 20c rapidly flash. The user is thus alerted that he has cabled the wrong ports, and the interactive map generating tool 26 continues to normally flash the icons 36a-b and LED 22b to indicate the appropriate ports to be cabled without moving on to the next set of ports in the cabling path process 32.

The cabling path process 32 continues until the component network 11 is properly and completely cabled. When finished, the user can disable the cabling path process 32 via interactive map generating tool 26, and turn off the wireless detector 16a in the server 12. This “disable” command is broadcast wirelessly to all satellite devices 14a-c and will allow all cabled/networked devices and their respective LEDs 22a-d to assume their normal functionality. Disabling may also turn off the satellite wireless detectors 16b-d for security purposes. Because the server 12 and satellite devices 14a-c are now cabled, the interactive map generating tool 26 can always enable the cabling path process 32 again at a later time (upon user prompt) without initially requiring the wireless detectors 16a-d to be on. The user can initiate disabling of the cabling path process 32 at any time during the cabling path process 32, as well as re-enable the cabling path process 32 at any time after the cabling path process 32 has been disabled.

It should be appreciated that the cabling path process 32 follows a physical cabling scheme desired for specific application of the component network 11. The cabling scheme refers to the actual physical manner in which the components of the component network 11 are to be cabled. The cabling path processes 32 may be installed in the interactive map generating tool 26 by a technology manufacturer to originally include a default cabling scheme. This default scheme would be automatically implemented by the interactive map generating tool 26 upon detection of the satellite devices 14a-c. In addition, specifically tailored cabling schemes, possibly in the form of an electronic configuration file, may later be provided to a customer via purchase from a technology provider, and used by the interactive map generating tool 26 to generate cabling path processes 32 including new cabling schemes that are tailored to particular applications that may or may not include additional satellite devices 14a-c. Upon installation of the electronic configuration file, these specifically tailored cabling schemes may also be automatically implemented by the interactive map generating tool 26 upon detection of the satellite devices 14a-c. When implementing these specifically tailored schemes after an original or previous scheme has been at least partially cabled, any server ports 20a or device ports 20b-d that include connections that have become obsolete and need to be de-cabled to allow cabling of the new scheme may be indicated as such via flashing LEDs 22a-d and de-cabling icons on the interactive physical location map 34 (as generated by the interactive map generating tool 26). A step in this new or re-cabling scheme may include disconnecting one or both sides of a existing cable 38, reconnecting an existing cable between new server ports 20a or device ports 20b-d, or adding new cable 38 to create an additional connection that was not present in a previous cabling scheme. Steps like these guide the user, allowing the component network 11 to transition from the old cabling scheme to the new or modified cabling scheme. During the cabling process 32, any servers or devices from a previous cabling scheme (that have since been removed from the network 11) may be at least temporarily identified on the physical location map 34, and may need to be addressed by the user (via manual interaction with the interactive map generating tool 26) in order begin or resume cabling.

The interactive map generating tool 26 may also receive custom cabling scheme information from the user, wherein the user custom designs at least a portion (i.e. some of the steps of) of the cabling scheme included in the cabling path process 32. These custom schemes may be saved in interactive map generating tool 26 for sharing with other users, or application at a later date.

It should be appreciated that the icons 36a-b, 40, and 42, and the LEDs 22a-d may be customized by the user to include any flashing/solid lighting activity the user may desire. It should also be appreciated that thought the Figures only show cabling between the server 12 and the satellite devices 14a-c, cabling may additionally occur between one satellite device and another.

Referring to FIG. 5, a method 100 for cabling a component network 11 is illustrated and includes powering a server wireless detector 16a disposed in a server 12 of the component network 11, wherein the server 12 includes at least one server port 20a, as shown in operational block 102. The method 100 also includes powering a satellite wireless detector 16b-d disposed in at least one satellite device 14a-c of the component network 11, wherein each of the satellite devices 14a-c includes at least one device port 20b-d, as shown in operational block 104. The method further includes detecting the at least one satellite device 14a-c via an information link 28a-c between the server wireless detector 16a and the satellite wireless detectors 16b-d, as shown in operational block 106, and acquiring information about the at least one satellite device 14a-c via the information link 28a-c between the server wireless detector 16a and the satellite wireless detectors 16b-d, as shown in operational block 108. The method 100 additionally includes generating an interactive physical location map 34 of the at least one satellite device 14a-c and the server 12 via the information link 28a-c, an interactive map generating tool 26, and a relative position coordinator 18a disposed in the server 12 and each of the at least one satellite devices 14a-c, as well as generating a cabling path process 32 via the map generating tool 26, both generations being shown in operational block 110. Still further, the method 100 includes indicating cable-ability along the cabling path process 32 and within the component network 11 by systematically flashing icons 36a-b associated with each of the at least one server ports 20a and each of the at least one device ports 20b-d on the physical location map 34, and systematically flashing a device LED 22b-d associated with each of the at least one device ports 20b corresponding with the flashing icons 36b and a server LED 22a associated with each of the at least one server ports 20a corresponding with the flashing icons 36a, as shown in operational block 112. The method 100 also includes directing a user along the cabling path process 32 via the indicating, as shown in operational block 114.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. A system for cabling comprising:
a component network comprising a server that includes a server wireless detector and at least one server LED associated with at least one server port, and at least one satellite device, each of said at least one satellite devices including a satellite wireless detector that is detectable by said server wireless detector and at least one device LED associated with at least one device port;
a relative position coordinator associated with said server and each of said at least one satellite devices; and
an interactive map generation tool associated with said server, said interactive map generating tool being capable of:
acquiring information about each of said at least one satellite devices via an information link between said server wireless detector and said satellite wireless detectors,
generating an interactive physical location map of said at least one satellite device and said server via said relative position coordinators, and directing a user along a cabling path process by systematically flashing icons associated with each of said at least one server ports and each of said at least one device ports on said physical location map, while flashing said device LEDs and said server LEDs that are associated with each of said at least one server ports and each of said at least one device ports that correspond with said flashing icons.

2. A system according to claim 1, wherein said relative position coordinator is at least one of a GPS chip and a wireless signal triangulation device.

3. A method for cabling comprising:
powering a server wireless detector disposed in a server a component network, said server including at least one server port;
powering a satellite wireless detector disposed in at least one satellite device of said component network, each of said satellite devices including at least one device port;
detecting said at least one satellite device via an information link between said server wireless detector and said satellite wireless detectors;
acquiring information about said at least one satellite device via said information link between said server wireless detector and said satellite wireless detectors;
generating an interactive physical location map of said at least one satellite device and said server via said information link, an interactive map generating tool, and a relative position coordinator disposed in said server and each of said at least one satellite devices;
generating a cabling path process via said map generating tool; and
indicating cable-ability along said cabling path process and within said component network by:
systematically flashing icons associated with each of said at least one server ports and each of said at least one device ports on said physical location map,
systematically flashing a device LED associated with each of said at least one device ports corresponding with said flashing icons and a server LED associated with each of said at least one server ports corresponding with said flashing icons, and
directing a user along said cabling path process via said indicating.

4. A method according to claim 3, further including flashing a connected icon on said physical location map via said map generating tool when at least one of said at least one server port and said at least one device port is properly cabled with one of said at least one device ports.

5. A method according to claim 3, further including flashing an error icon on said physical location map via said map generating tool when at least one of said at least one server port and said at least one device port is improperly cabled with one of said at least one device ports.

6. A method according to claim 3, further including solidly lighting server LEDs that are associated with server ports that are properly cabled, and solidly lighting device LEDs that are associated with properly cabled device ports.

7. A method according to claim 3, further including rapidly flashing server LEDs that are associated with server ports that are improperly cabled, and rapidly flashing device LEDs that are associated with improperly cabled device ports.

8. A method according to claim 3, further including said user designing at least a portion of said cabling path process.

9. A method according to claim 3, further including disabling said cabling path process, and allowing said component network to assume normal functionality.

10. A method according to claim 9, further including enabling said cabling path process after said disabling has occurred.

11. A method according to claim 3, further including generating a de-cabling indicators for any of at least one devices ports and said at least one server ports that should no longer be cabled within said component network.
